(19) United States
(12) Patent Application Publication
(10) Pub. No.: US 2026/0216633 A1
(43) Pub. Date: Jul. 30, 2026

(54) CO2 ADSORPTION SYSTEM AND METHOD FOR CO2 ADSORPTION USING HUMIDITY STABLE POLYSTYRENE-DIVINYLBENZENE AMINE FUNCTIONALIZED POLYMERIC ADSORBENTS

(71) Applicant: CLIMEWORKS AG, Zurich (CH)

(72) Inventors: Angelo VARGAS, Zürich (CH); Davide ALBANI, Zürich (CH); Livia MÜLLER, Zürich (CH); Ruth GARCIA, Zürich (CH); Olivier DUBÉ, Zürich (CH)

(73) Assignee: CLIMEWORKS AG, Zurich (CH)

(21) Appl. No.: 18/720,161

(22) PCT Filed: Dec. 6, 2022
(86) PCT No.: PCT/EP2022/084528

§ 371 Date: Jun. 14, 2024

(30) Foreign Application Priority Data
Dec. 16, 2021 (EP) 21215249.0

(51) Int. Cl. B01D 53/04; B01D 53/047; B01J 20/26; B01J 20/28; B01J 20/32; B01J 20/34

(52) U.S. Cl. CPC B01D 53/0438; B01D 53/0462; B01D 53/0476; B01J 20/261; B01J 20/28004; B01J 20/28019; B01J 20/28052; B01J 20/28059; B01J 20/28071; B01J 20/28073; B01J 20/28076; B01J 20/28085; B01J 20/321; B01J 20/3244; B01J 20/3458; B01D 2253/202; B01D 2253/25; B01D 2253/306; B01D 2253/308; B01D 2253/31; B01D 2253/311; B01D 2257/504; B01D 2258/0283; B01D 2258/05; B01D 2258/06; B01D 2259/4009

(57) ABSTRACT

Method for separating gaseous carbon dioxide from air, in particular from ambient atmospheric air (1), by cyclic adsorption/desorption using a sorbent material (3), wherein said sorbent material (3) is a solid inorganic or organic, non-polymeric or polymeric support material functionalized on the surface with amino functionalities capable of reversibly binding carbon dioxide, with a specific BET surface area, preferably measured by nitrogen adsorption, in the range of 10-25 m²/g and with a pore volume distribution such that the cumulative pore volume in the range of 50-350 nm is in the range of 0.3-1.5 cm³/g.

The present invention relates to uses of sorbent material materials for separating gaseous carbon dioxide from a gas mixture, in particular for direct air capture (DAC) as well as to corresponding processes, in particular for the direct capture of carbon dioxide from atmospheric air.

### PRIOR ART

The Paris Agreement led to a consensus about the threat of climate change and the need of a global response to keep the global temperature rise well below 2 degrees Celsius above pre-industrial levels. To achieve this target, multiple possibilities have been suggested, from the planting of new forests to technological means. Forestation has broad resonance with the public opinion but the scope and feasibility of such projects is debated and is likely to be less simple an approach as believed.

Among the technological approaches, the most advanced technologies include sequestration of CO₂ from point sources such as flue gas capture, and direct capture of CO₂ from air, referred to as direct air capture (DAC). Both technological strategies have potential to mitigate climate change.

The specific advantages of CO₂ capture from the atmosphere over flue gas capture include: DAC (i) can address the emissions of distributed sources (e.g. cars, planes); (ii) does not need to be attached to the source of emission but can be at a location independent thereof; (iii) can address emissions from the past thus enabling negative emissions if combined with a safe and permanent method to store the CO₂ (e.g., through underground mineralization). DAC is also used as one of several means of providing a key reactant for the synthesis of renewable materials or fuels as e.g. described in WO-A-2016/161998.

In terms of suitable capture material, several DAC technologies have been described in literature, such as for example, the utilization of alkaline earth oxides in water to form calcium carbonate as described in e.g. US-A-2010034724. Different approaches comprise the utilization of solid CO₂ adsorbents, hereafter named sorbents, which are characterized by the use of a packed bed and where CO₂ is captured at the gas-solid interface. Such sorbents can contain different types of amino functionalization and polymers, such as immobilized aminosilane-based sorbents as reported in U.S. Pat. No. 8,834,822, and amine-functionalized cellulose as disclosed in WO-A-2012/168346.

WO-A-2011/049759 describes the utilization of an ion exchange material comprising an aminoalkylated bead polymer for the removal of carbon dioxide from industrial applications.

WO-A-2016/037668 describes a sorbent for reversibly adsorbing CO₂ from a gas mixture, where the sorbent is composed of a polymeric adsorbent having a primary amino functionality and a having a high specific surface area (calculated with the Brunauer-Emmet-Teller method) of 25-75 m²/g and a specific average pore diameter. The materials are regenerated after capture by applying pressure or humidity swing.

WO-A-2016/038339 describes a process for removing carbon dioxide using a polymeric adsorbent having primary amine units immobilized on a solid support. The regeneration of the sorbent is then done by heating the sorbent in a temperature range between 55 and 75° C. while flowing air through it.

U.S. Pat. Nos. 6,716,888 and 6,503,957 describe a process for introducing ground ion exchange resins into a polymer binder melting at temperatures of 125-130° C. and forming the heterogeneous mixture into a sheet form of maximum thickness 0.125 mm for usage in water purification.

US-A-2012076711 discloses a structure containing a sorbent with amine groups that is capable of a reversible adsorption and desorption cycle for capturing CO₂ from a gas mixture wherein said structure is composed of fiber filaments wherein the fiber material is carbon and/or polyacrylonitrile.

US-A-2018043303 discloses a porous adsorbent structure that is capable of a reversible adsorption and desorption cycle for capturing CO₂ from a gas mixture and which comprises a support matrix formed by a web of surface modified cellulose nanofibers. The support matrix has a porosity of at least 20%. The surface modified cellulose nanofibers consist of cellulose nanofibers having a diameter of about 4 nm to about 1000 nm and a length of 100 nm to 1 mm that are covered with a coupling agent being covalently bound to the surface thereof. The coupling agent comprises at least one monoalkyldialkoxyaminosilane.

US-A-2019224647 provides novel solid sorbents synthesized by the reaction of polyamines with polyaldehyde phosphorous dendrimer (P-dendrimer) compounds. The sorbents are stable and exhibit rapid reaction kinetics with carbon dioxide, making the sorbents applicable for carbon capture, and can be easily regenerated for further use. The material is stable to aqueous and organic media, as well as strong acid and bases. The sorbent maintains full capacity over extended use. The material can be used for CO₂ capture from pure CO₂ streams, mixed gas streams, simulated flue gas, and ambient air. Additionally, the material can be adhered to surfaces for reversible CO₂ capture applications outside of bulk particle-based processes.

US-A-2017203249 discloses a method for separating gaseous carbon dioxide from a mixture by cyclic adsorption/desorption using a unit containing an adsorber structure with sorbent material, wherein the method comprises the following steps: (a) contacting said mixture with the sorbent material to allow said gaseous carbon dioxide to adsorb under ambient conditions; (b) evacuating said unit to a pressure in the range of 20-400 mbarabs and heating said sorbent material with an internal heat exchanger to a temperature in the range of 80-130° C.; and (c) re-pressurisation of the unit to ambient atmospheric pressure conditions and actively cooling the sorbent material to a temperature larger or equal to ambient temperature; wherein in step (b) steam is injected into the unit to flow-through and contact the sorbent material under saturated steam conditions, and wherein the molar ratio of steam that is injected to the gaseous carbon dioxide released is less than 20:1.

Irani et al (“Facilely synthesized porous polymer as support of poly (ethyleneimine) for effective CO₂ capture”, Energy (157), p. 1-9 (2018)) proposes an effective adsorbent (polyHIPE/PEI) for use in CO₂ capture technologies. For this purpose, a porous polymer was prepared by high internal phase emulsion (HIPE) using 2-Ethylhexyl methacrylate (EHMA) and divinylbenzene (DVB). This prepared porous polymer (polyHIPE) was then used as a novel support for the wet impregnation of polyethylenimine (PEI), thus resulting in the polyHIPE/PEI adsorbent. The prepared adsorbent was characterized. At the optimal PEI loading of 60 wt % on polyHIPE, the CO₂ sorption capacity reached 4 mmol CO₂/g-sorbent using 10 vol % CO₂ and 3 vol % H₂O in N₂ at 70° C. Kinetic and thermodynamic adsorption studies showed that the activation energies for CO₂ adsorption and desorption of polyHIPE/PEI are 13.74 kJ/mol and 36.12 kJ/mol, respectively.

Jung et al in Energy Fuels 2014, 28, 3994-4001 report that solid amine sorbents having adequate particle size with high CO₂ adsorption capacity were prepared using poly(ethylenimine) (PEI) as the amine and mesoporous poly(methyl methacrylate) (PMMA) beads as the support. The PEI-impregnated PMMA-supported sorbent exhibited CO, adsorption capacity up to 4.26 mmol/g with PMMA-55 at 75° C. in pure CO, gas flow. The effect of the temperature on the adsorption capacity of PMMA-55 was investigated, and the maximum adsorption capacity was obtained at 50° C. with a CO₂ exposure time of 180 min, different from the tendency of most silica supported sorbents. The effect of surfactant addition on the adsorption performance of PMMA-supported sorbents differed from those of silica-supported sorbents because of the different surface characteristics between PMMA and silica. Adsorption/desorption cycling was also performed to examine the suitability of the amine sorbent for potential application.

Hammache et al. in Energy & fuels report that an amine sorbent, prepared by impregnation of polyethyleneimine on silica, was tested for steam stability. The stability of the sorbent was investigated in a fixed bed reactor using multiple steam cycles of 90 vol. % H2O/He at 105° C. and the gas effluent was monitored with a mass spectrometer. CO2 uptake of sorbent was found to decrease with repeated exposure to steam. Characterization of the spent sorbent using N2 physisorption, SEM, and thermogravimetric analysis (TGA), showed that the decrease in CO2 loading can possibly be attributed to a reagglomeration of the amine in the pores of the silica. No support effect was found in this study. The commercial SiO2 used, Cariact G10, was found to be stable under the conditions used. While it was found that subjecting the sorbent to several steam cycles decreased its CO2 uptake, a continuous exposure of the sorbent to steam did not have a significant performance impact. A silanated sorbent, consisting of a mixture of PEI and aminopropyl-triethoxysilane on SiO2 support, was also investigated for steam stability. Similarly to the non-silanated sorbent, the CO2 loading of this sorbent decreased upon steam exposure, although a mechanism for this change has not been postulated.

U.S. Pat. No. 6,279,576 B1 relates to a regenerative absorber device for the removal of CO2, from expiration gases during anesthesia. The device comprises a container having an inlet for said expiration gases, and an outlet for output gases, the CO, content of which having been substantially removed therefrom. The device is provided with an ion exchanger having the capability to absorb CO2 disposed in said container such that the gases flow through said ion exchanger from said inlet to said outlet. A novel method of anesthesia comprises use of a CO2 absorber device.

Liu et al in J. APPL. POLYM. SCI. 2017, 134, 45046, report how a solid amine adsorbent was prepared by modifying a porous polystyrene resin (XAD-4) with chloroacetyl chloride: through a Friedel-Crafts acylation reaction, followed by aminating with tetraethylenepentamine (TEPA). The adsorption behavior of CO2, from a simulated flue gas on the solid amine adsorbent was evaluated. Factors that could determine the CO, adsorption performance of the adsorbents such as amine species, adsorption temperature, and moisture were investigated. The experimental results showed that the solid amine adsorbent modified with TEPA (XAD-4-TEPA), which had a longer chain, showed an amine efficiency superior to the other two amine species with shorter chains. The CO2 adsorption capacity decreased obviously as the temperature increased because the reaction between CO2 and amine groups was an exothermic reaction, and its adsorption amount reached 1.7 mmol/g, at 10° C. in dry conditions. The existence of water could significantly increase the CO2, adsorption amount of the adsorbent promoting the chemical adsorption of CO2 on XAD-4-TEPA. The adsorbent kept almost the same adsorption amount after 10 cycles of adsorption-desorption. All of these results indicated that amine-functionalized XAP-4 resin was a promising CO2 adsorbent.

US 2017/0203249 relates to a method for separating gaseous carbon dioxide from a mixture by cyclic adsorption/desorption using a unit containing an adsorber structure with sorbent material, wherein the method comprises the following steps: (a) contacting said mixture with the sorbent material to allow said gaseous carbon dioxide to adsorb under ambient conditions; (b) evacuating said unit to a pressure in the range of 20-400 mbar, and heating said sorbent material to a temperature in the range of 80-130° C.; and (c) re-pressurisation of the unit to ambient atmospheric pressure conditions and actively cooling the sorbent material to a temperature larger or equal to ambient temperature; wherein in step (b) steam is injected into the unit to flow-through and contact the sorbent material under saturated steam conditions, and wherein the molar ratio of steam that is injected to the gaseous carbon dioxide released is less than 20:1.

### SUMMARY OF THE INVENTION

The present invention relates to methods for separating gaseous carbon dioxide from a gas mixture, preferably from at least one of ambient atmospheric air, flue gas and biogas, in particular to DAC methods, using a particular sorbent material as well as to uses of such particular sorbent materials for gas separation purposes, in particular DAC.

Herein is the following is shown: Prior art claims that in particular cross-linked polystyrene sorbents substituted with primary aminoalkyl functional groups and featuring a high specific surface area, but also other sorbents based on inorganic or organic, non-polymeric or polymeric materials having a high specific surface area, are particularly useful for DAC applications. Surprisingly now it was found, contrary to that perception, that inorganic or organic, non-polymeric or polymeric materials, in particular (but not exclusively) cross-linked polystyrene sorbents, for example cross-linked polystyrene sorbents based on divinylbenzene (DVB), so e.g. (poly(styrene-co-divinylbenzene)), functionalized with amino groups, such inorganic or organic, non-polymeric or polymeric materials having a specific surface area in a very particular medium range combined with a pore volume distribution that is in a particular range—namely the cumulative pore volume in the range of 50-350 nm has to be in the range of 0.28-1.5 cm³/g—show, in a steam desorption process, an unexpectedly stable carbon dioxide adsorption behavior essentially independent of humidity conditions. This is of primordial importance for the stability of the processes over different weather and input gas composition conditions, i.e. under conditions with variable relative humidities (RH, for example being defined as the amount of water vapour present in air expressed as a percentage of the amount needed for saturation at the same temperature, which here is given as 15° C. for the experiments using steam desorption, typically in the entry airstream of a DAC device with the corresponding sorbent; the relative humidities given here were produced by using a humidifier system in which a dry stream (RH 0%) with a saturated stream were mixed in different ratio depending on the targeted RH. The saturated stream was produced by bubbling dry gas through a water column. The relative humidities were determined using a device of the type Vaisala Humidity and Temperature Probe HMP110). In the exemplary adsorption tests done after air purge thermal swing desorption, the temperature of the reactor was kept to 30° C., and the RH was controlled by changing the temperature of a bubbler where the inlet gas is fed through it to reach the target RH values at 30° C.

Specifically, according to the invention the sorbent material is a solid inorganic or organic, non-polymeric or polymeric support material functionalized on the surface with amino functionalities capable of reversibly binding carbon dioxide, with a specific BET surface area, in the range of 10-25 m²/g and with a pore volume distribution such that the cumulative pore volume in the range of 50-350 nm pore sizes is in the range of 0.28-1.5 cm³/g or 0.3-1.5 cm³/g.

In fact, one of the unexpected findings of the research was that in case of steam desorption there are sorbent materials which are apt for high relative humidities (RH % larger than 60%) and there are sorbent materials which are apt for low relative humidities (RH % in the range of 0-60%). The former are characterised by having a specific surface area of up to 10 m²/g, while the latter are characterised by having a specific surface area of above 25 m²/g.

Surprisingly, if the specific BET surface area of such a sorbent material, i.e. a sorbent material based on inorganic or organic, non-polymeric or polymeric materials, on the other hand is in the claimed window of 10-25 m²/g, and if such sorbent material has a cumulative porosity in the window of 50-350 nm as detailed below, it was found that the corresponding sorbent materials are essentially stable in carbon dioxide adsorption behavior across the full relative humidity range of 0-100%, without impaired overall capacity reduction.

This behaviour is specific to the situation of steam desorption. In fact if desorption without steam, in particular heat desorption processes are used, this surprisingly stable behaviour of relative humidity independent capture capacity selectively for this type of porosity is not found, as will be evidenced in detail further below.

The stable carbon dioxide capture capacity over variable relative humidity allows for a correspondingly stable and controllable process of high efficiency independent of the relative humidity conditions and a corresponding optimised process control for sorbent material based on inorganic or organic, non-polymeric or polymeric materials.

Interestingly, independent of the specific surface area values, all these sorbent materials behaving differently in steam desorption processes essentially have the same carbon dioxide capture behavior when used in an air purge thermal swing, i.e. when desorption takes place just by heating and not by introduction of steam. The carbon dioxide adsorption under these conditions for these sorbent materials slightly increases for an increasing relative humidity over the full range. This behaviour is likely due to the increase of amine efficiency at higher RH as well described in the literature. In such process at each cycle the sorbent material is desorbed by heating the sorbent material bed (resistive heat) and passing air and/or N₂ through the bed.

On the contrary, when the sorbent material bed is regenerated by condensing steam instead of heating the bed by induction, one unexpectedly obtains a different behavior. Specifically one observes a completely different dependence upon RH %. Sorbent materials with low surface area behave at best at high RH %, while they do not behave well at low RH %. Sorbent materials with high surface area on the other hand behave well at lower RH %, while they lose capacity at higher RH %.

The sorbent materials with the characteristics as claimed on the other hand behave significantly more constantly across the relevant RH % spectrum.

This is due to the special surface and porosity characteristics of the sorbent material as claimed, and especially the presence of a larger cumulative pore volume in the range of the larger pores.

The invention is therefore relative to a sorbent material that also has the apt morphology (surface area, preferably also total pore volume, and pore size distribution) to work across a spectrum of RH % without too much variation of cyclic CO₂ capture capacity, therefore allowing for continuous and relatively constant plant operation through the different times of the day (e.g. humid nights vs dry days) and across seasonal changes (hot and humid summer and dry and cold winters).

The specific characteristics of such sorbent material are a surface area between 10-25 or 10-20 m²/g, high pore volume of large pores (in particular pore diameter >100 nm, pore volume in the range 50-350 nm, 0.28-1.5 cm³/g or 0.3-1.5 cm³/g).

These sorbent materials can be polymeric or non-polymeric as their basis. The sorbent materials can also be organic or inorganic, but also hybrid forms are possible. The main characterizing feature of these sorbent materials is not so much the chemistry, but the physical properties of the porous structure.

In particular, it shows that if the functionalized solid support of the sorbent material has a porosity in the claimed range and has a high proportion and volume of macropores (pores with diameters exceeding 50 nm) and further preferably also has a low proportion or is essentially free from mesopores i.e. pores with diameters between 2 and 50 nm, and/or preferably also has a low proportion or is essentially free from micropores i.e. pores with diameters not exceeding or below 2 nm, this leads to a reduction of accumulation of condensed water in the porosity and for the carbon dioxide capture process in the presence of water and/or steam to a much higher capacity in cyclic operation.

In the context of this disclosure, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.8 to 1.1 barabs and typically ambient atmospheric temperature refers to temperatures in the range of −40 to 60° C., more typically −30 to 45° C. The gas mixture used as input for the process is preferably ambient atmospheric air, i.e. air at ambient atmospheric pressure and at ambient atmospheric temperature, which normally implies a CO₂ concentration in the range of 0.03-0.06% by volume. However, also air with lower or higher CO₂ concentration can be used as input for the process, e.g. with a concentration of 0.1-0.5% by volume, so generally speaking preferably the input CO₂ concentration of the input gas mixture is in the range of 0.01-0.5% by volume. However, also flue gas can be the source, in this case the input CO₂ concentration of the input gas mixture is typically in the range of up to 20% or up to 12% by volume, preferably in the range of 1-20% or 1-12% by volume.

In the carbon dioxide capture method step sequence (a)-(e) as detailed herein, in steps (a) and (e) reference is made to ambient atmospheric pressure conditions and ambient atmospheric temperature conditions. This only applies if the supplied gas mixture is provided under these conditions, for example in case of direct air capture, where the source of the gas mixture is atmospheric air. If, however the source of gas mixture is a different source, it may well be that the supply conditions are not ambient atmospheric pressure and/or are not ambient atmospheric temperature conditions. In particular, in case of flue gas, the gas mixture can be and often will be at an elevated temperature, for example at a temperature above room temperature, it may even be at a temperature above 50° C. The temperature may even go up to 70° C., and in that case normally the setup is adapted such that the temperature to desorb the carbon dioxide from the sorbent material in step (c) is at least 10° C., preferably at least 20° C. higher than that temperature of the supply gas. So, under these non-atmospheric temperature and pressure conditions in step (a) and in step (e) normally the pressure and temperature conditions are different, specifically contacting in step (a) takes place under temperature and pressure conditions of the supplied gas mixture, and in step (e) the sorbent material is brought to the temperature and pressure conditions of the supplied gas mixture.

The properties of the ambient atmospheric air to which the sorbent material is exposed in terms of both temperature and humidity range have a strong influence on the performance of amine-based sorbent materials. For example, in dry conditions (i.e., relative humidity, RH=0%) amines show an efficiency, defined as the stoichiometric coefficient of the reaction between the amino group and CO₂, of 2:1, while in humid conditions the efficiency is of 1:1. There are benefits of high relative humidity of the gas stream containing carbon dioxide on the adsorption capacity, defined as the mole of CO₂ captured per kilogram of sorbent, during the adsorption step. Prior art does not disclose the effect of high relative humidity of the gas stream containing CO₂ on the cyclic adsorption/desorption performance when the sorbent material is desorbed using steam.

More generally speaking, the present invention proposes a method for separating gaseous carbon dioxide from a gas mixture, preferably from ambient atmospheric air, containing said gaseous carbon dioxide as well as further gases different from gaseous carbon dioxide, by cyclic adsorption/desorption using a sorbent material adsorbing said gaseous carbon dioxide in a unit. If in the following reference is made to ambient atmospheric air, this also includes other gas mixtures like flue gas and biogas.

The method comprises at least the following sequential and in this sequence repeating steps (a)-(e):
(a) contacting said gas mixture, preferably ambient atmospheric, air with the sorbent material to allow at least said gaseous carbon dioxide to adsorb on the sorbent material by flow-through through said unit, preferably under ambient atmospheric pressure conditions (if ambient atmospheric air is pushed through the device using a ventilator for the like, this is still considered ambient atmospheric pressure conditions in line with this application, even if the air which is pushed through the reactor by the ventilator has a pressure slightly above the surrounding ambient atmospheric pressure, and the pressures to is in the ranges as detailed above in the definition of “ambient atmospheric pressures”) and ambient atmospheric temperature conditions, in an adsorption step;
(b) isolating said sorbent material with adsorbed carbon dioxide in said unit from said flow-through preferably while essentially maintaining the temperature in the sorbent material;
(c) injecting a stream of saturated or superheated steam by flow-through through said unit and thereby inducing an increase of the temperature of the sorbent material to a temperature between 6° and 110° C., starting the desorption of CO₂;
(d) extracting at least the desorbed gaseous carbon dioxide from the unit and separating gaseous carbon dioxide from steam by condensation downstream of the unit;
(e) bringing the sorbent material to ambient atmospheric temperature conditions (if the sorbent material is not cooled in this step down to exactly the surrounding ambient atmospheric temperature conditions, this is still considered to be according to this step, preferably the ambient atmospheric temperature established in this step (e) is in the range of the surrounding ambient atmospheric temperature+25° C., preferably +10° C. or +5° C.).

As pointed out above, according to the invention said sorbent material is a solid inorganic or organic, non-polymeric or polymeric support material functionalized on the surface with amino functionalities capable of reversibly binding carbon dioxide, which has a specific BET surface area, determined by applying the BET method as described in ISO 9277, and preferably based on measurements of nitrogen adsorption, in the range of 10-25 m²/g. So BET (Brunauer, Emmett und Teller) surface area analysis is used for the determination of the specific BET surface area applying the method as described in ISO 9277 and with a pore volume distribution such that the cumulative pore volume in the range of 50-350 nm is in the range of 0.28-1.5 cm³/g or 0.3-1.5 cm³/g.

According to a first preferred embodiment, said sorbent material has a specific BET surface area, preferably measured by nitrogen adsorption, in the range of 10-20 m²/g, preferably in the range of 12-20 m²/g.

Further preferably said sorbent material has a pore diameter distribution, measured by mercury intrusion, such that 90%, preferably 95% of the pore volume is in the range of 50-400 nm, preferably in the range of 80-350 nm. For the parameters used for the mercury intrusion measurements reference is made to the details in the specification further below. Alternatively or additionally, said sorbent material preferably has a pore volume distribution, measured by mercury intrusion, such that the maximum pore volume is at a pore diameter in the range of 80-150 nm, preferably in the range of 100-150 nm. The distribution is preferably such that 90%, more preferably 95% of the total pore volume of the distribution is in a window of −50 nm and +150 nm, preferably of −40 and +100 nm around the diameter of said maximum of the pore volume distribution.

According to yet another preferred embodiment, said sorbent material has a total pore volume, measured by Mercury intrusion, in the range 0.3-1 cm³/g, preferably 0.35-0.80 cm³/g, most preferably in the range of 0.4-0.7 cm³/g.

The sorbent material can also be characterised by way of its nitrogen content. According to another preferred embodiment, said sorbent material thus has a nitrogen content in the range 5-50 wt. %, preferably in the range or 6-15 or 8-15 wt. % or 10-12 wt. %, in each case for dry sorbent material. The dryness for this determination is defined as treating 6 g of the sorbent material at 90° C. for 90 min under a N₂ flow of 2 L/min.

As pointed out above, the method with the special sorbent material can be carried out basically at any practical relative humidity (RH %), but has the advantage, that it is particularly suitable and stable over variable relative humidity conditions, i.e. where RH % ranges between 20 and 80%.

The solid inorganic or organic, non-polymeric or polymeric support material of the sorbent material can be based on an organic or inorganic, preferably organic polymeric support, for example thermoplastic or thermoset materials. Also possible are thermoplastic materials, which are cross-linked in a subsequent step to synthesis. The solid polymeric support material can be cross-linked polymeric material such as a polystyrene or polyvinyl material, which can be cross-linked by using divinyl aromatics, preferably a styrene divinylbenzene copolymer (poly(styrene-co-divinylbenzene), PS-DVB). The solid support material can be in the form of beads which can be monodisperse or hetero-disperse.

To introduce e.g. an aminomethyl functionality to the PS-DVB backbone, the following reaction path can be conducted:

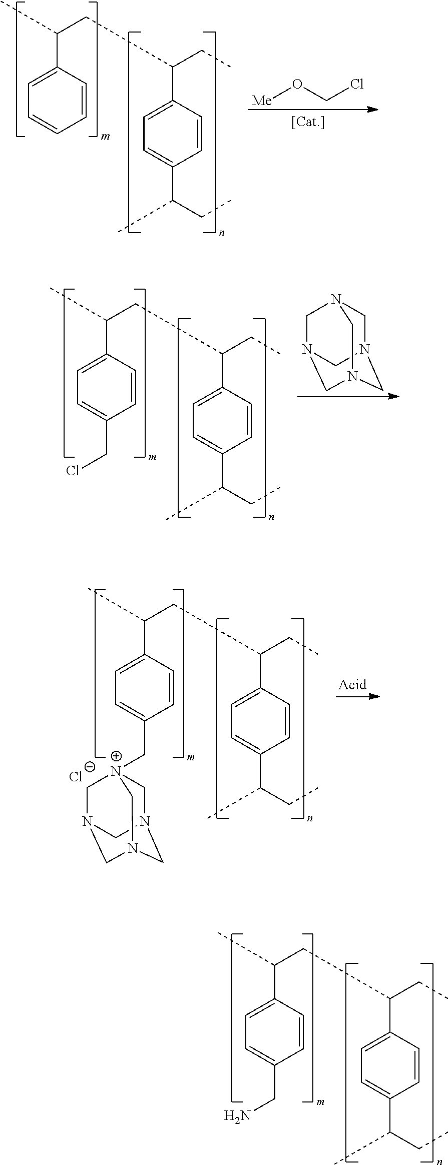

In the first step PS-DVB can be chloromethylated using chloromethylmethyl ether and a catalyst such as AlCl3 (a) to form a chloromethyl group attached to the PS-DVB skeleton. After that, the amino group can be introduced via reaction with hexamethylenetetramine (b). As one can see from the structure in step c, this results in the formation of a quaternary ammonium salt that cannot covalently bind CO₂. In order to have a primary amine able of binding CO₂, the intermediate in step c can be hydrolysed with HCl, which not only leads to the primary amine but also leads to the reaction of the amine via an acid base reaction, forming ammonium chloride. To get the amine in the final state as free base for capture, a final reaction with NaOH can be carried out. The final structure of the aminomethyl PS-DVB sorbent used in the DAC process as given in the experimental evidence further below is shown in step d.

The solid inorganic or organic, non-polymeric or polymeric support material of the sorbent material can also be an inorganic non-polymeric support, preferably selected from the group consisting of: silica (SiO₂), alumina (Al₂O₃), titania (TiO₂), magnesia (MgO), clays, as well as mixed forms thereof, such as silica-alumina (SiO₂—Al₂O₃), or mixtures thereof.

The solid support material of the sorbent material can be in the form of hollow or solid particles, beads, microspheres, monolithic structures, sheets, hollow or solid fibres, preferably in woven or nonwoven structures, or extrudates.

The solid inorganic or organic, non-polymeric or polymeric support material of the sorbent material can also take the form of particles (powders or granules, e.g. having an average size (D50) between 0.002 and 4.0 mm) of such a support material, which can be embedded in a solid matrix in the form of a composite.

The sorbent material is given by the support material functionalised on the surface with amino functionalities and the sorbent material shows the claimed specific surface area and the claimed pore volume distribution. Such sorbent material can take various three-dimensional forms as mentioned, it can take the form of a monolith, layer, sheet, the form of hollow or solid fibres, or particles. These structures can then also and preferably be forming or be embedded in a superstructure either without further elements, for example when fibres take the form of a woven or nonwoven structure, or when particles are formed into a monolithic structure made from the sorbent material particles. The superstructures however can also comprise further structural elements. For example it is possible to have a laminate structure, which comprises layers of porous material, for example a polymeric woven or nonwoven material, which itself is not a sorbent material, and one or more layers of sorbent material, either in the form of a powder or particulate structures, can be attached to one or both sides of such a layer. Or a layer of sorbent material is embedded in two outer layers of porous material. In the latter preferred case, where sorbent material is sandwiched between two or more outer layers of an air permeable/porous material, preferably a polymeric air permeable/porous material, which can also take the form of a layer with a semipermeable membrane, these laminates, which can be soft or stiff, can then be structured to form further superstructures for example panels with air channels, for example in the form of such laminates with sorbent arranged in zigzag or wavy patterns. Such panels can then even form higher level superstructures like modules with stiff frames and outer surface covering meshes to provide for structures which can easily be handled and replaced.

It should be noted that the porosity characteristics, so the specific surface area and the pore volume distribution, but also the total pore volume and the other characterising parameters as detailed herein in relation with the sorbent material as such, may and very often will be different for the overall of such a superstructure. So such a superstructure as a whole comprising the special sorbent material may and very often will have porosity characteristics which are different from the claimed ranges due to the additional layers et cetera. However, for the actual carbon dioxide capture properties what is relevant is the specific surface area and the pore volume distribution of the embedded sorbent material, and that, in such a superstructure, has to meet the above-mentioned specific surface area and pore volume distribution characteristics (and preferably the further characterisations as detailed herein). Specifically, if for example there is a laminate with outer non-sorbent porous layers and a central layer of sorbent material according to the invention, the cumulative pore volume due to the contribution of the non-sorbent layers of the full structure can be significantly larger than of the embedded sorbent material alone.

When talking about a solid matrix forming the solid inorganic or organic, non-polymeric or polymeric support material as a composite in the context of this aspect of the invention, this means that the solid matrix conclusively provides for the actual three-dimensional structure forming the solid inorganic or organic, non-polymeric or polymeric support material of the sorbent material itself (however not excluding the sorbent material being embedded or attached to further structural elements not contributing to the carbon dioxide capture). This aspect may include situations where a separate structure provides for an actual carrier which is then coated, impregnated or soaked with a binder forming a composite solid matrix with the sorbent material particles and subsequently dried, cross-linked or solidified in another way, and where the binder provides for adhering the sorbent material particles to the actual carrier and/or forming a coating on that carrier together with the sorbent material particles.

Preferably, such a composite formed exclusively by the solid matrix and the sorbent material particles can take the form of sheets or foils, but also granules or monolithic structures are possible. These elements providing the solid inorganic or organic, non-polymeric or polymeric composite can be mounted in or on a corresponding carrier structure, for example in some kind of a frame or the like for the actual carbon dioxide capture process.

In particular foils or sheets of such a composite material including the solid inorganic or organic, non-polymeric or polymeric support material of the sorbent material can be obtained by extrusion, wherein e.g. said particles of sorbent material functionalized on the surface are added to for example a thermoplastic matrix material after melting thereof and prior to the thermoforming. This is possible by melt mixing or solution casting but it is also possible by sputtering sorbent material particles onto a liquid or at least surface softened layer of the thermoplastic material of the solid matrix if need be followed by a lamination process between rolls.

Alternatively it is possible to use a precursor material of the solid matrix, add the sorbent material particles to that precursor material, mix it, and then solidify the material, for example in a cross-linking, sintering or drying process, leading for example to a thermoset structure. Preferably in such a process involving heating it is made sure that the residence time of the sorbent material particles in the molten or precursor material is sufficiently short to avoid degradation of the surface and/or porosity properties and/or of the functionalisation of the particles.

Further it is possible to generate the actual adsorber structure starting out from sorbent material particles in a sintering process, e.g. by bringing the sorbent material particles into a corresponding desired three-dimensional shape (e.g. into the form of a layer of essentially the desired thickness for the resulting foil) and to then heat and/or irradiate and/or chemically treat the corresponding structure similar to a sintering process to generate a coherent macroscopic adsorber structure. This is particularly suitable for sorbent materials based on organic thermoplastic polymeric materials. It is however e.g. also possible for other materials if these materials are provided with a corresponding binder on the surface allowing for such a sintering process. Such a sintering can be assisted by slight pressing, e.g. in a lamination process.

The solid matrix can also again be a same or different solid inorganic or organic, non-polymeric or polymeric support material functionalized on the surface with amino functionalities, even having itself the surface and porosity properties as defined above. However, it can also be a material which is different from the one of the particles and does not have a carbon dioxide capture property and/or whose matrix does not have the surface area and porosity characteristics as defined above. Preferably, the solid matrix in this case is a different material from the sorbent material particles which does not have a surface functionalisation but which is preferably porous and in which the sorbent material particles are exposed on the surface with their functionalised surface to be able to act as carbon dioxide capture moieties.

Also, such a composite form material with sorbent material particles embedded in solid matrix can be in the form of hollow or solid particles, beads, microspheres, monolithic structures, sheets, hollow or solid fibres, preferably in woven or nonwoven structures, meshes, or extrudates.

A corresponding powder to be embedded in a matrix can be obtained by milling or grinding a particulate resin material which is already surface functionalised.

Such sheets or foils preferably have a thickness in the range of 0.01-5 mm or 0.05-3 mm, preferably in the range of 0.1-1 mm, for the envisaged DAC applications to provide for the required mechanical properties.

To withstand the conditions of typical DAC processes, it is furthermore preferable that the solid matrix material with the embedded sorbent material particles forming the composite structure and/or the solid inorganic or organic, non-polymeric or polymeric support material in general, at the typical DAC processing conditions, does not or at least not significantly lose its mechanical properties to an extent impairing the performance in the DAC process.

Therefore typically, in case of amorphous thermoplastic polymeric materials for the solid matrix or the support material in general, the glass transition temperature should be higher than 100° C., and in case of thermoplastic systems with a melting point, the melting point should be higher than 100° C. On the other hand, considering in particular particles which are already functionalised when combined with the matrix, and very particularly considering such polymeric particles, e.g. based on polystyrene, which on the surface is functionalised, the matrix material should not have a processing temperature which is too high, since otherwise in the melt mixing process the polymeric particles will also melt and/or the surface functionalisation of the particles will be destroyed. Considering this, the matrix material and/or support material of the sorbent material in general should preferably have, in case of amorphous thermoplastic polymeric materials, a glass transition temperature lower than 180° C. In case of amorphous thermoplastic polymeric materials preferably the glass transition temperature is therefore in a range of 120-160° C., more preferably in the range of 130-150° C. In case of matrix systems and/or support material in general having a melting point (e.g. microcrystalline or partly crystalline polymeric systems), the melting point or softening point should be in the range of the same temperatures, so it should be higher than 100° C., and/or lower than 180° C., preferably in the range of 120-160° C., more preferably in the range of 130-150° C. Glass transition temperatures and melting temperatures in the present context are to be considered measured according to DIN EN ISO 11357 (2012). Amorphous in the sense of the present invention means that the system has an enthalpy of fusion determined according to ISO 11357 (2012) of less than or equal to 3 J/g.

It should be noted and emphasized again, that the above-mentioned surface area properties and the porosity properties are to be considered in as far as they are relevant for the carbon dioxide capture process. If therefore for example a matrix material is permeable for carbon dioxide, the composite may have a porosity and/or surface area structure which is not within the ranges as claimed and as given above, since that is determined largely by the solid matrix material. However, the sorbent material particles embedded in such a material do have the porosity and/or surface area structure as defined above, and these properties are available for the carbon dioxide capture process by virtue of the fact that the matrix material is permeable to the carbon dioxide and allows access to the capture active particles by way of diffusion.

So such a composite structure can for example be produced by blending the sorbent material particles with the solid matrix material or a predecessor thereof, and subsequent solidification and/or extrusion. So the solid matrix material can for example be a thermoplastic material or a material which only solidifies upon treatment after mixture, e.g. in a cross-linking or drying or sintering process.

Surface functionalisation for carbon dioxide capture in this case can either be carried out before blending and forming the corresponding composite, or after. Possible is for example also a process, in which the particles without functionalisation and the matrix material are mixed, a corresponding porous composite structure is generated having the desired porosity characteristics, and subsequently the functionalisation on the surface of the embedded particles with amino functionalities is carried out on the solid composite structure. This has the advantage that a non-functionaliseable matrix material can be combined with functionaliseable particles in a composite, the composite is first generated and the composite is only subsequently and only on the corresponding available surface of the particles functionalised with amino functionalities as defined above. The particles embedded in the composite are to be regarded as a sorbent material in the above sense.

Such a solid support is preferably surface functionalised to form the sorbent material, wherein preferably the surface functionalisation leads to amine groups available for reversible carbon dioxide capture wherein the surface functionalization can be achieved by impregnation or by grafting with a surface species of the solid support, or a combination thereof. The surface functionalization is preferably provided with amino methyl moieties such as benzylamine moieties, wherein the solid polymeric support material is preferably obtained in an suspension polymerisation process. Emulsion polymerisation can be efficiently used to establish the porosity in the claimed range by adapting the reactants and the reaction conditions, and preferably the suspension polymerisation is carried out in water with or without using a surfactant such as dimethyldioctadecaylammonium chloride, preferably in the presence of a pore-forming agent, which can be isooctane, toluene, wax or a mixture thereof. But also other methods and reagents are possible. Functionalisation can for example be achieved by phthalimide addition or chloromethylation. Preferably, the primary amine moieties take the form of terminal amino methyl, e.g. in the form of the above-mentioned benzylamine moieties. For carbon dioxide capture, the primary amine is, according to present knowledge, converted to a carbamic acid compound, which dissociates a high temperature and/or humidity for the release of the carbon dioxide.

The solid inorganic or organic, non-polymeric or polymeric support material can be a polymeric support material in the form of at least one of monolith (typically having a sponge-like structure for flow-through of gas mixture/ambient air), the form of a layer or a plurality of layers, sheets, the form of hollow or solid fibres, for example in woven or nonwoven (layer) structures, but can also take the form of hollow or solid particles (beads). Preferably it takes the form of preferably essentially spherical beads with a particle size (D50) in the range of 0.002-4 mm, 0.005-2 mm or 0.01-1.5 mm, preferably in the range of 0.30-1.25 mm. Possible are also particles with a particle size (D50) in the range of 0.002-1.5 mm, 0.005-1.6 mm.

In the unit the sorbent material, if it takes the form of beads or powder in the range 0.002-4 mm, can be contained in layered structures/containers having air permeable side walls in the form of a membrane, metal grids or the like, the latter normally having a mesh width which is sufficiently large to provide for a low pressure drop across the corresponding structure, but sufficiently small to make sure that the particles of the sorbent material are retained in the corresponding containers.

The sorbent material can have a water retention in the range of 3-60 weight percent, preferably in the range of 3-30 weight percent or 5-30 weight percent. The water retention in this case is determined using a moisture analyser which heats up the sorbent material to 110° C. until the weight change detected is not larger than 0.002 g/15 seconds.

Furthermore, the sorbent material can have a bulk density (EN ISO 60 (DIN 53468)) in the range 750-400 kg/m³, preferably 450-650 kg/m³.

Step (d) of extraction is preferably carried out while still contacting the sorbent material with steam by injecting and/or circulating saturated or superheated steam into said unit, thereby flushing and purging both steam and CO₂ from the unit, and preferably while regulating the extraction and/or steam supply to essentially maintain the temperature in the sorbent at the end of the preceding step (c) and/or to essentially maintain the pressure in the sorbent at the end of the preceding step (c). “Essentially maintaining the pressure in the sorbent at the end of the preceding step” in practice means that the pressure is not allowed to deviate more than by ±100 mbar, preferably more than ±50 mbar, more preferably more than ±20 mbar from the pressure at the end of step (c). In practice certain very short time deviations even beyond this range may be produced after transitioning from step c) to d) due to processes of pressure equalization and depend on the exact realization of the equipment for carrying out the process. However they are of short duration on the order of less than 15% of the duration of step d).

For carrying out the method preferably a unit is used containing said sorbent material, the unit and the sorbent material being able to sustain a temperature of at least 60° C. for the desorption of at least said gaseous carbon dioxide and the unit being openable to flow-through of the gas mixture/ambient atmospheric air and for contacting it with the sorbent material for the adsorption step.

The unit used may comprise an array of individual adsorber elements, each adsorber element comprising at least one support layer and at least one sorbent layer comprising or consisting of at least one sorbent material, where said sorbent material offers selective adsorption of CO₂ in the presence of moisture or water vapor, wherein the adsorber elements in the array can be arranged essentially parallel to each other and spaced apart from each other forming parallel fluid passages for flow-through of gas mixture/ambient atmospheric air and/or steam. Essentially parallel in this context means that angles between the planes of the adsorber elements when seen over the complete lengths of the adsorber elements do not exceed a value of 10°, preferably do not exceed a value of 5°, preferably are smaller than 2°. Individual adsorber elements in this context means that the adsorber elements are not a monolithic structure but can be independently from one another arranged to form essentially parallel channels of an array wherein the layers are connected to each other with corresponding linking structures, for example by way of a rack into which the layers are inserted or at which the layers are fastened or over which a support layer can be repeatedly pleated at a desired spacing.

Said unit is preferably evacuable to a vacuum pressure of 400 mbar(abs) or less, and step (b) may include isolating said sorbent with adsorbed carbon dioxide in said unit from said flow-through while maintaining the temperature in the sorbent and then evacuating said unit to a pressure in the range of 20-400 mbar(abs), wherein in step (c) injecting a stream of saturated or superheated steam is also inducing an increase in internal pressure of the reactor unit, and wherein step (e) includes bringing the sorbent material to ambient atmospheric pressure conditions and ambient atmospheric temperature conditions.

Preferably, after step (d) and before step (e) the following step is carried out:

(d1) ceasing the injection and, if used, circulation of steam, and evacuation of the unit to pressure values between 20-500 mbar(abs), preferably in the range of 50-250 mbar(abs) in the unit, thereby causing evaporation of water from the sorbent and both drying and cooling the sorbent.

Step (e) is preferably carried out exclusively by contacting said ambient atmospheric air with the sorbent material under ambient atmospheric pressure conditions and ambient atmospheric temperature conditions to evaporate and carry away water in the unit and to bring the sorbent material to ambient atmospheric temperature conditions.

After step (b) and before step (c) the following step can be carried out:

(b1) flushing the unit of non-condensable gases by a stream of non-condensable steam while essentially holding the pressure of step (b), preferably holding the pressure of step (b) in a window of ±50 mbar, preferably in a window of ±20 mbar and/or holding the temperature below 75° C. or 70° C. or below 60° C., preferably below 50° C.

In a further embodiment of the step b1, the temperature of the adsorber structure rises from the conditions of step (a) to 80-110° C. preferably in the range of 95-105° C.

In step (b1) the unit can preferably be flushed with saturated steam or steam overheated by at most 20° C. in a ratio of 1 kg/h to 10 kg/h of steam per liter volume of the adsorber structure, while remaining at the pressure of step (b1), to purge the reactor of remaining gas mixture/ambient air. The purpose of removing this portion of ambient air is to improve the purity of the captured CO₂.

In step (c), steam can be injected in the form of steam introduced byway of a corresponding inlet of said unit, and steam can be (partly or completely) recirculated from an outlet of said unit to said inlet, preferably involving reheating of recirculated steam, or by the re-use of steam from a different reactor.

It should be noted that heating for desorption according to this process in step (c) is only effected by this steam injection and there is no additional external or internal heating e.g. by way of tubing with a heat fluid.

In step (c) furthermore preferably the sorbent material can be heated to a temperature in the range of 80-110° C. or 80-100° C., preferably to a temperature in the range of 85-98° C.

According to yet another preferred embodiment, in step (c) the pressure in the unit is in the range of 700-950 mbar(abs), preferably in the range of 750-900 mbar(abs).

In addition, the present invention relates to the use of a sorbent material having a solid inorganic or organic, non-polymeric or polymeric support material functionalized on the surface with amino functionalities capable of reversibly binding carbon dioxide, with a specific BET surface area, preferably measured by nitrogen adsorption, in the range of 10-25 m²/g and with a pore volume distribution, preferably measured by Hg intrusion, such that the cumulative pore volume in the range of 50-350 nm is in the range of 0.28-1.5 cm³/g for direct air capture, in particular using a temperature, vacuum, or temperature/vacuum swing process.

This is using a process in which injecting a stream of saturated or superheated steam by flow-through is used for inducing an increase of the temperature of the sorbent material to a temperature between 6° and 110° C., starting the desorption of CO₂.

Preferably, the sorbent material for this use is characterised as detailed above in terms of pore diameter, pore volume and/or nitrogen content, et cetera.

Last but not least the present invention relates to a direct air capture unit comprising at least one reactor unit containing sorbent material suitable and adapted for flow-through of gas mixture, preferably ambient air,
wherein the reactor unit comprises an inlet for gas mixture/ambient air and an outlet for gas mixture/ambient air during adsorption,
wherein the reactor unit is heatable to a temperature of at least 60° C. for the desorption of at least said gaseous carbon dioxide and the reactor unit being openable to flow-through of the gas mixture/ambient atmospheric air and for contacting it with the sorbent material for an adsorption step, wherein preferably the reactor unit is further evacuable to a vacuum pressure of 400 mbar(abs) or less,
wherein the sorbent material preferably takes the form of an adsorber structure comprising an array of individual adsorber elements, each adsorber element preferably comprising at least one support layer and at least one sorbent material layer comprising or consisting of at least one sorbent material, where said sorbent material comprises a solid inorganic or organic, non-polymeric or polymeric support material functionalized on the surface with amino functionalities capable of reversibly binding carbon dioxide, with a specific BET surface area, preferably measured by nitrogen adsorption, in the range of 10-25 m²/g and with a pore volume distribution, preferably measured by Hg intrusion, such that the cumulative pore volume in the range of 50-350 nm is in the range of 0.28-1.5 cm³/g, which offers selective adsorption of CO₂ in the presence of moisture or water vapor, wherein preferably the adsorber elements in the array are arranged essentially parallel to each other and spaced apart from each other forming parallel fluid passages for flow-through of gas mixture/ambient atmospheric air and/or steam,
at least one device, preferably a condenser, for separating carbon dioxide from water,
wherein preferably at the gas outlet side of said device for separating carbon dioxide from water, preferably said condenser, there is at least one of, preferably both of a carbon dioxide concentration sensor and a gas flow sensor for controlling the desorption process.

The present application also relates to methods for producing surface functionalized solid support materials suitable and adapted for these processes, in particular including surface impregnation or grafting for surface functionalization.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic representation of a direct air capture unit;

FIG. 2 shows the pore size distribution measured by Hg porosimetry;

FIG. 3 shows the pore volume as a function of the pore size measured by Hg intrusion;

FIG. 4 shows the equilibrium adsorption capacity of the sorbents at 30° C. using an air flow rate of 2 L/min and 60% RH after an air purge thermal swing desorption at 94° C.;

FIG. 5 shows the cyclic adsorption capacity using a gas stream with a volumetric flowrate of 11 L/min containing 450 ppm of CO₂ and at 15° C. at different RH of the sorbents after steam desorption;

FIG. 6 shows the cyclic adsorption capacity of the sorbents at 30° C. using an air flow rate of 2 L/min at different RH after an air purge thermal swing desorption at 94° C.

### DESCRIPTION OF PREFERRED EMBODIMENTS

The presented sorbent materials can be produced using processes as follows:

For a general reaction scheme to introduce an aminomethyl functionality to the PS-DVB backbone reference is made to the scheme given further up in this disclosure.

The morphology of PS-DVB beads can be controlled by the amount of DVB in the monomer phase and the amount and type of porogen. Generally speaking, the larger the amount of DVB at constant porogen type and amount leads to a larger specific surface area. On the other hand, a larger amount of porogen results in larger pore diameter and lower specific surface area. To obtain a specific morphology (e.g., surface area, pore volume and pore diameter), an optimum between the amount of DVB, the amount of porogen and type of porogen is to be adjusted.

The different porosities in the examples IER_A-IER_D given in the following have been established using these guidelines.

### Procedure for the Synthesis IER_A:

In a 1 L reactor, 1% (mass ratio) of gelatin and 2% (mass ratio) of sodium chloride are dissolved in 350 mL of water at 45° C. for 1 h. In another flask, 1 g of benzoyl peroxide is dissolved in a mixture of 55.4 g of styrene, 8.2 g of divinylbenzene (content 80%) and 52.6 g of C11-C13 iso-paraffin. The resulting mixture is then added to the reactor. After that the reaction mixture is stirred and heated up to 70° C. maintaining the temperature for 2 h, then the temperature is raised to 80° C. and kept it for 3 h, and then raised to 90° C. for 6 h. The reaction mixture is cooled down to room temperature and the beads are filtered off using a funnel glass filter and vacuum suction. The beads are washed with toluene and dried in rotavapor.

The polystyrene-divinylbenzene beads are functionalized using the chloromethylation reaction. 5 g of so obtained beads are added to a 3-neck flask containing 50 mL of chloromethyl methyl ether. The mixture is stirred for 1 h, 2 g of zinc chloride is added and is heated to 40° C. and kept it for 24 h. After that, the beads are filtered off and wash with 25% HCl and water to obtain chloromethylated beads. To obtain benzylamine units, the chloromethylated beads are aminated using the following procedure. The chloromethylated beads are added to a three-necked flask with 27 g of methylal and the mixture is stirred for 1 h. To this mixture, 16 g of hexamethylenetetramine and 13 g of water are added and kept under gentle reflux for 24 h. The beads are filtered off and washed with water. To have a primary amine, a hydrolysis step followed by a treatment with a bases are required. The beads are placed in a 3-neck flask containing 140 mL of a solution of hydrochloric acid (30%)-ethanol (95%) (volume ratio of 1:3), the reaction mixture is heated to 80° C. and kept at this temperature for 20 h. After that, the beads are filtered off and washed with water. At this stage the amine is protonated and to free the base, the beads are treated with 50 mL of an NaOH solution 2 M, and stirred with 1 h at 80° C. The aminated beads are filter off and washed to neutral pH with demineralized water.

### Procedure for the Synthesis IER_B:

In a 1 L reactor, 1% (mass ratio) of gelatin and 2% (mass ratio) of sodium chloride are dissolved in 340 mL of water at 45° C. for 1 h. In another flask, 1 g of benzoyl peroxide is dissolved in a mixture of 59.7 g of styrene, 3.9 g of divinylbenzene (content 80%) and 65.3 g of C11-C13 iso-paraffin. The resulting mixture is then added to the reactor. After that the reaction mixture is stirred and heated up to 70° C. maintaining the temperature for 2 h, then the temperature is raised to 80° C. and kept it for 3 h, and then raised to 90° C. for 6 h. The reaction mixture is cooled down to room temperature and the beads are filtered off using a funnel glass filter and vacuum suction. The beads are washed with toluene and dried in rotavapor.

The polystyrene-divinylbenzene beads are functionalized using the chloromethylation reaction. 5 g of so obtained beads are added to a 3-neck flask containing 50 mL of chloromethyl methyl ether. The mixture is stirred for 1 h, 2 g of zinc chloride is added and is heated to 40° C. and kept it for 24 h. After that, the beads are filtered off and wash with 25% HCl and water to obtain chloromethylated beads. To obtain benzylamine units, the chloromethylated beads are aminated using the following procedure. The chloromethylated beads are added to a three-necked flask with 27 g of methylal and the mixture is stirred for 1 h. To this mixture, 16 g of hexamethylenetetramine and 13 g of water are added and kept under gentle reflux for 24 h. The beads are filtered off and washed with water. To have a primary amine, a hydrolysis step followed by a treatment with a bases are required. The beads are placed in a 3-neck flask containing 140 mL of a solution of hydrochloric acid (30%)-ethanol (95%) (volume ratio of 1:3), the reaction mixture is heated to 80° C. and kept at this temperature for 20 h. After that, the beads are filtered off and washed with water. At this stage the amine is protonated and to free the base, the beads are treated with 50 mL of an NaOH solution 2 M, and stirred with 1 h at 80° C. The aminated beads are filter off and washed to neutral pH with demineralized water.

### Procedure for the Synthesis IER_C:

In a 1 L reactor, 1% (mass ratio) of gelatin and 2% (mass ratio) of sodium chloride are dissolved in 340 mL of water at 45° C. for 1 h. In another flask, 1 g of benzoyl peroxide is dissolved in a mixture of 58.8 g of styrene, 4.9 g of divinylbenzene (content 80%) and 63.2 g of C11-C13 iso-paraffin. The resulting mixture is then added to the reactor. After that the reaction mixture is stirred and heated up to 70° C. maintaining the temperature for 2 h, then the temperature is raised to 80° C. and kept it for 3 h, and then raised to 90° C. for 6 h. The reaction mixture is cooled down to room temperature and the beads are filtered off using a funnel glass filter and vacuum suction. The beads are washed with toluene and dried in rotavapor.

The polystyrene-divinylbenzene beads are functionalized using the chloromethylation reaction. 5 g of so obtained beads are added to a 3-neck flask containing 50 mL of chloromethyl methyl ether. The mixture is stirred for 1 h, 2 g of zinc chloride is added and is heated to 40° C. and kept it for 24 h. After that, the beads are filtered off and wash with 25% HCl and water to obtain chloromethylated beads. To obtain benzylamine units, the chloromethylated beads are aminated using the following procedure. The chloromethylated beads are added to a three-necked flask with 27 g of methylal and the mixture is stirred for 1 h. To this mixture, 16 g of hexamethylenetetramine and 13 g of water are added and kept under gentle reflux for 24 h. The beads are filtered off and washed with water. To have a primary amine, a hydrolysis step followed by a treatment with a bases are required. The beads are placed in a 3-neck flask containing 140 mL of a solution of hydrochloric acid (30%)-ethanol (95%) (volume ratio of 1:3), the reaction mixture is heated to 80° C. and kept at this temperature for 20 h. After that, the beads are filtered off and washed with water. At this stage the amine is protonated and to free the base, the beads are treated with 50 mL of an NaOH solution 2 M, and stirred with 1 h at 80° C. The aminated beads are filter off and washed to neutral pH with demineralized water.

### Procedure for the Synthesis IER_D:

In a 1 L reactor, 1% (mass ratio) of gelatin and 2% (mass ratio) of sodium chloride are dissolved in 340 mL of water at 45° C. for 1 h. In another flask, 1 g of benzoyl peroxide is dissolved in a mixture of 57.8 g of styrene, 5.86 g of divinylbenzene (content 80%) and 63.84 g of C11-C13 iso-paraffin. The resulting mixture is then added to the reactor. After that the reaction mixture is stirred and heated up to 70° C. maintaining the temperature for 2 h, then the temperature is raised to 80° C. and kept it for 3 h, and then raised to 90° C. for 6 h. The reaction mixture is cooled down to room temperature and the beads are filtered off using a funnel glass filter and vacuum suction. The beads are washed with toluene and dried in rotavapor.

The polystyrene-divinylbenzene beads are functionalized using the chloromethylation reaction. 5 g of so obtained beads are added to a 3-neck flask containing 50 mL of chloromethyl methyl ether. The mixture is stirred for 1 h, 2 g of zinc chloride is added and is heated to 40° C. and kept it for 24 h. After that, the beads are filtered off and wash with 25% HCl and water to obtain chloromethylated beads. To obtain benzylamine units, the chloromethylated beads are aminated using the following procedure. The chloromethylated beads are added to a three-necked flask with 27 g of methylal and the mixture is stirred for 1 h. To this mixture, 16 g of hexamethylenetetramine and 13 g of water are added and kept under gentle reflux for 24 h. The beads are filtered off and washed with water. To have a primary amine, a hydrolysis step followed by a treatment with a bases are required. The beads are placed in a 3-neck flask containing 140 mL of a solution of hydrochloric acid (30%)-ethanol (95%) (volume ratio of 1:3), the reaction mixture is heated to 80° C. and kept at this temperature for 20 h. After that, the beads are filtered off and washed with water. At this stage the amine is protonated and to free the base, the beads are treated with 50 mL of an NaOH solution 2 M, and stirred with 1 h at 80° C. The aminated beads are filter off and washed to neutral pH with demineralized water.

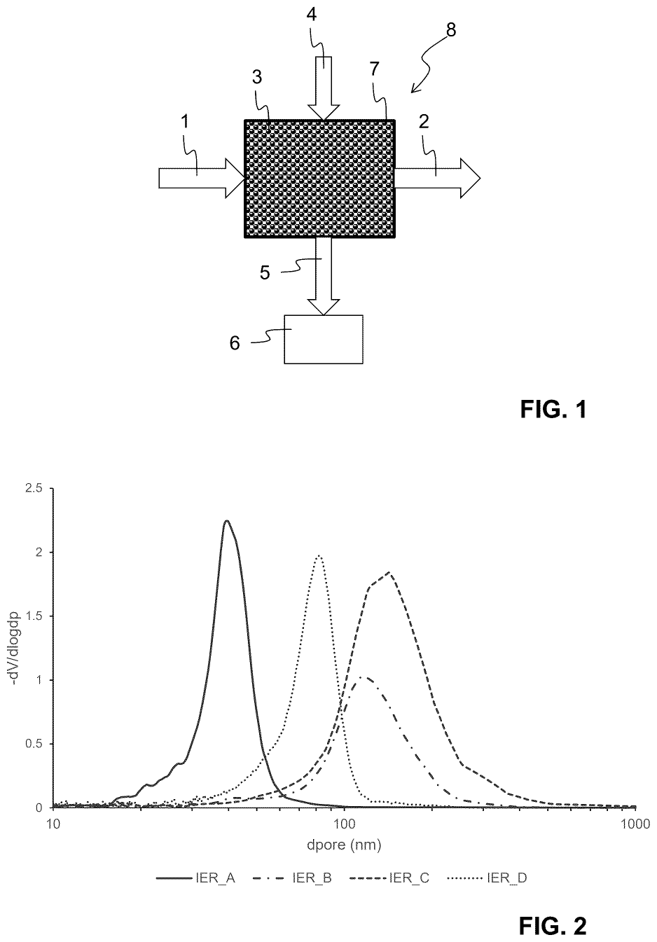

The beads according to the examples were tested in an experimental rig in which the beads were contained in a packed-bed reactor or in air permeable layers. The rig is schematically illustrated in FIG. 1. There is an ambient air inflow structure 1 and the actual reactor unit 8 comprises a container or wall 7 within which the layers of sorbent material 3 are located. There is an inflow structure 4 for desorption, if for example steam is used for desorption, and there is a reactor outlet 5 for extraction. Further, there is a vacuum unit 6 for evacuating the reactor.

For the adsorption measurements using dry gas to desorb the sorbent, 6 g of dry sample was filled into a cylinder with an inner diameter of 40 mm and a height of 40 mm and placed into a CO₂ adsorption/desorption device, where it was exposed to a flow of 2.0 NL/min of air at 30° C. containing 450 ppmv CO₂, having a relative humidity of 20, 40, 60, and 80% for a duration of 600 min. Prior to adsorption, the sorbent bed was desorbed by heating the sorbent to 94° C. using an air flow of 2.0 NL/min. The amount of CO₂ adsorbed on the sorbent was determined by integration of the signal of an infrared sensor measuring the CO₂ content of the air stream leaving the cylinder.

For the adsorption measurements using steam to desorb the sorbent, 15 g of dry sample was filled into a squared reactor with an inner diameter of 60 mm and a height of 60 mm and placed into a CO₂ adsorption/desorption device, where it was exposed to a flow of 11 NL/min of air at 15° C. containing 450 ppmv CO₂ and having a relative humidity of 20, 40, 60, and 80% for a duration of 600 min. Prior to adsorption, the sorbent bed was brought to 200 mbarabs and then 3 mL/min of steam was injected into the reactor to reach a temperature in the sorbent bed of ca 95° C., the sorbent was kept at this temperature for 6 min. After that the reactor was closed and the pressure was set to 200 mbarabs, once the targeted pressure was reached the reactor was re-pressurized to atmospheric pressure. The amount of CO₂ adsorbed on the sorbent was determined by integration of the signal of an infrared sensor measuring the CO₂ content of the air stream leaving the reactor.

### Specific Examples

In this example section, four samples have been analyzed and compared: one with high surface area, having a BET surface area >25 m2/g, which is herein after referred to high surface area polymer (IER_A); and the second one with low surface area, <25 m²/g which is herein after referred to as low surface area polymer (IER_B).

Further analyzed are two samples of the same basic structure but with optimum surface area and porosity distribution, namely IER_C and IER_D.

### Pore Size, Pore Volume and Specific Surface Area of Sorbents:

### Method for the Specific Surface Area Measurements:

Nitrogen adsorption measurements were performed at 77 K on a Quantachrome ASiQ. The mass of the sample used was between 0.2-1.0 g. Since the samples contain a significant amount of water, it is important to use a treatment that does not alter their intrinsic porosity and pore structure. Therefore, prior to degassing, the samples were treated using the elutropic row method, which comprises removing water and replacing it with organic solvents with lower boiling point in the following order: methanol, acetone, and n-heptane. 2 g of samples was place in a chromatography column with a frit and flushed with 20 cm3 of each solvent in decreasing polarity order. The sample was then spread out on a petri dish and placed in a vacuum oven at 40° C. for 24 hours. After that, the sample was degassed at 70° C. under vacuum for twelve hours before measurement.

BET (Brunauer, Emmett und Teller) surface area analysis was used applying the method ISO 9277.

Results for the specific surface area measurements are given in the below table 1:

TABLE 1
Specific surface area calculated and determined by
N₂ adsorption measurements using the BET method.

| Sample ID | SBET/m² g⁻¹ |
|---|---|
| IER_A | 44.2 |
| IER_B | 8.8 |
| IER_C | 13 |
| IER_D | 19 |

### Mercury Porosimetry Measurements:

Mercury porosimetry measurements were performed to analyze the pore sizes and pore volumes not accessible through N₂ adsorption measurements. In order to perform mercury porosimetry measurements the following parameters were used:
Mercury surface tension: 0.48 N/m
Mercury contact angle: 150°
Max. pressure: 400 MPa
Increase speed: 6-19 MPa/min

Prior to Hg porosimetry, the samples were degassed under vacuum at 70° C. for 12 h.

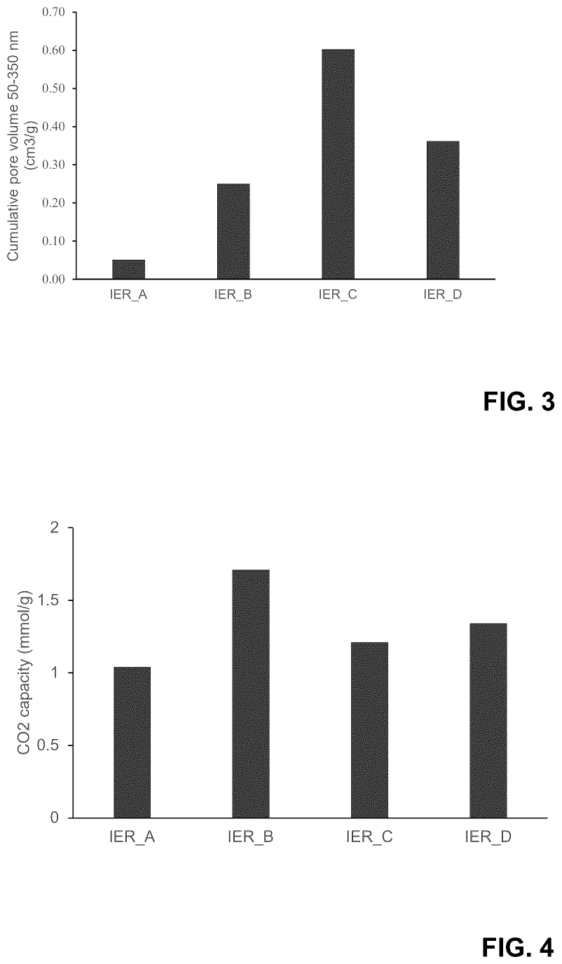

The results of Hg porosimetry analysis are presented in FIG. 2 and FIG. 3 and summarized in the following table 2:

TABLE 2
Porosity data obtained by Hg porosimetry

| | | | Cumulative pore |
|---|---|---|---|
| | | | volume in |
| | Total pore volume/ | | the range |
| Sample ID | cm³ g⁻¹ | Diameter pore/nm | of 50-350 nm |
| IER_A | 0.42 | 20-60 | 0.05 |
| IER_B | 0.30 | 50-300 | 0.25 |
| IER_C | 0.65 | 50-350 | 0.60 |
| IER_D | 0.41 | 20-110 | 0.36 |

### Elemental Analysis:

Elemental analysis of the materials was carried out using a LECO CHN-900 combustion furnace. Prior to the measurement, the samples were ground in a mortar and treated under N₂ flow (2 L/min) at 90° C. for 2 h.

The analysis results for the materials are summarised in tables 3-6

TABLE 3
Elemental analysis results of IER_A

| | | | | Average/ |
|---|---|---|---|---|
| Element | Nr. 1/wt. % | Nr. 2/wt. % | Nr. 3/wt. % | wt. % |
| C | 79.70 | 80.41 | 78.55 | 79.55 |
| H | 8.06 | 8.10 | 8.43 | 8.01 |
| N | 8.46 | 8.43 | 7.91 | 8.27 |

TABLE 4
Elemental analysis results of IER_B

| Element | Nr. 1/wt. % | Nr. 2/wt. % | Average/wt. % |
|---|---|---|---|
| C | 78.59 | 78.56 | 78.58 |
| H | 8.26 | 8.25 | 8.26 |
| N | 10.88 | 10.99 | 10.94 |

TABLE 5
Elemental analysis results of IER_C

| Element | Nr. 1/wt. % | Nr. 2/wt. % | Average/wt. % |
|---|---|---|---|
| C | 81.05 | 81.08 | 81.07 |
| H | 8.16 | 8.17 | 8.17 |
| N | 9.37 | 9.12 | 9.25 |

TABLE 6
Elemental analysis results of IER_D

| Element | Nr. 1/wt. % | Nr. 2/wt. % | Average/wt. % |
|---|---|---|---|
| C | 77.90 | 77.85 | 77.88 |
| H | 8.04 | 8.16 | 8.10 |
| N | 8.70 | 8.69 | 8.70 |

### Adsorption Measurements:

6 g of dry sample was filled into a cylinder with an inner diameter of 40 mm and a height of 40 mm and placed into a CO₂ adsorption/desorption device, where it was exposed to a flow of 2.0 NL/min of air at 30° C. containing 450 ppmv CO₂, having a relative humidity of 60% corresponding to a temperature of 30° C. for a duration of 600 min. Prior to adsorption, the sorbent bed was desorbed by heating the sorbent to 94° C. under an air flow of 2.0 NL/min. The amount of CO₂ adsorbed on the sorbent was determined by integration of the signal of an infrared sensor measuring the CO₂ content of the air stream leaving the reactor. The CO₂ equilibrium capacities at 30° C. and 60% RH are shown in FIG. 4. As we can see, IER_B sorbent presents the largest CO₂ cumulative capacity (1.7 mmol/g) compared to the other sorbents, which show equilibrium capacities between 1.1 and 1.3 mmol/g. The difference in equilibrium capacities is due to the different amine loading in the sample as evidenced by the different nitrogen content of the sorbents (see Tables 3-6). If the RH of the inlet gas is changed between 20 and 80%, all sorbents show a linear increase of the cyclic CO₂ capacity as shown in FIG. 6. This behaviour is consistent to what it is known about the RH dependency for amine-based sorbents.

The results of the CO₂ adsorption measurements are summarized in Table 7.

TABLE 7
CO₂ cumulative adsorption capacity for the sorbents

| | cumulative CO₂ capacity/mmol CO₂ |
|---|---|
| Sample ID | per g of dry sorbent |
| IER_A | 1.1 |
| IER_B | 1.7 |
| IER_C | 1.2 |
| IER_D | 1.3 |

### Cyclic Adsorption/Desorption Measurements:

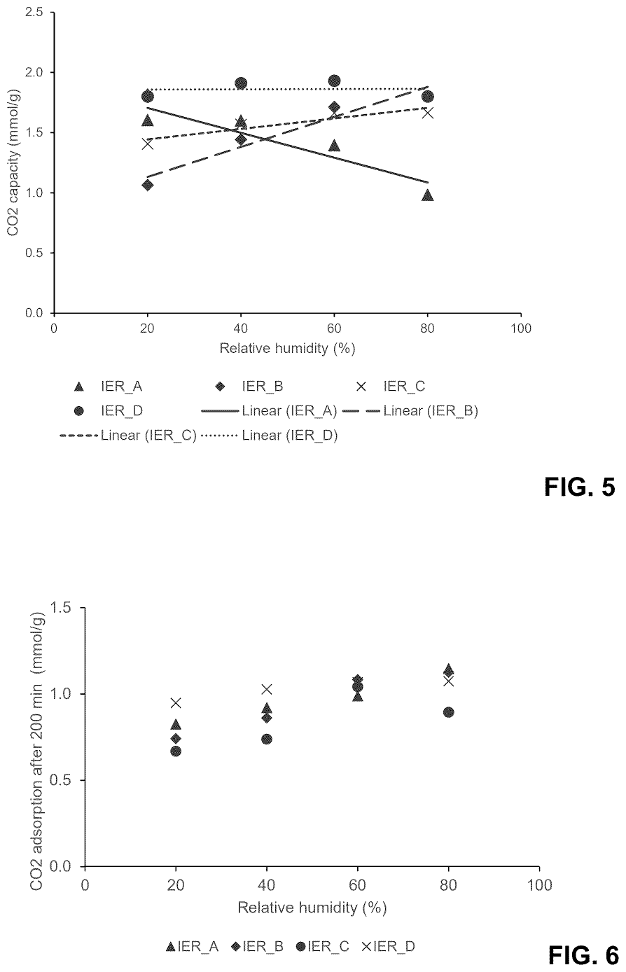

The cyclic adsorption/desorption capacity was measured in consecutive runs at relative humidity of the ambient air in the range 20-80% The desorption process was performed using a warm fluid to increase the temperature of the sorbent. In this specific example, saturated steam was employed. The sorbent bed was first adsorbed for 200 min using ambient air. Once the adsorption was completed, the pressure of the system was brought down to 200 mbarabs. As soon as the pressure is reached, saturated steam is supplied to the sorbent bed up to reaching a temperature of ca 95° C. After that, the sorbent was brought to 200 mbarabs until a temperature of 60° C. is reached. This cycle was repeated multiple times and the results are shown in FIG. 5.

FIG. 6 shows the results of similar experiments, but in this case the desorption process was performed by heating the sorbent to 94° C. using an air flow of 2.0 NL/min. This cycle was repeated multiple times.

By applying steam to desorb the sorbent and using air with RH in the range 20-80%, the desorption capacity of IER_A shows a constant decay in cyclic adsorption/desorption capacity, while IER_B shows a constant increase in cyclic adsorption/desorption capacity until it becomes constant at RH around 80%. Only IER_C and IER_D show an essentially constant behavior over the RH ranges measured.

The sorbent material can generally also be a solid inorganic non-polymeric support material functionalized on the surface with amino functionalities capable of reversibly binding carbon dioxide, with a specific BET surface area, in the range of 10-25 m²/g and with a pore volume distribution such that the cumulative pore volume in the range of 50-350 nm is in the range of 0.3-1.5 cm³/g.

Silica (SiO₂), alumina (Al₂O₃), silica-alumina (SiO₂—Al₂O₃), titania (TiO₂), magnesia (MgO), clays, mixtures of the above are possible.

As for the organic polymeric materials, preferably for these organic or organic, non-polymeric support materials the total pore volume, measured by mercury intrusion, is in the range of 0.3-0.7 cm³/g and/or the pore diameter distribution, measured by mercury intrusion, is such that 90%, preferably 95% of the pore volume it is in the range of 50-300 nm.

For the case of silica microspheres having these porosity characteristics, they can be produced using the following scheme:

Monodisperse colloidal SiO₂ was prepared by the seeded growth method. The seeds, commercially available Ludox AS-40 silica sol particles, were added to a mixture of ammonia (2 mol/L), deionised water (6 mol/L), and ethanol to form a suspension. Tetraethylorthosilicate (TEOS, 2.2 mol/L) was added to the mixture under stirring at a controlled speed while keeping the reaction mixture at 25° C. The monodisperse SiO₂ particles were obtained by the growth of seeds. Monodisperse SiO₂ microspheres with diameters of 500 nm were obtained and then calcined at 700° C. for 2 h, and followed by a hydrothermally treatment at 220° C. for 5 h to recover the surface silanol groups which were lost during the calcination.

The resulting silica material has a specific surface area of 10 m²/g, a median pore diameter of 95 nm, a total pore volume determined by Hg intrusion porosimetry of 0.3 cm³/g, and an average particle size of 500 μm.

For the case of alumina microspheres having these porosity characteristics, they are commercially available, for example, from Saint Gobain Nor Pro-catalyst carriers. Alpha-alumina not having surface hydroxyl groups can be used for modification by impregnation. For the case of titania microspheres having these porosity characteristics, they are commercially available from Saint Gobain Nor Pro-catalyst carriers. Rutile titania not having surface hydroxyl groups can be used for modification by impregnation.

LIST OF REFERENCE SIGNS

| | |
|---|---|
| 1 | ambient air, ambient air |
| | inflow structure |
| 2 | outflow of ambient air behind |
| | adsorption unit in adsorption |
| | flow-through mode |
| 3 | sorbent material |
| 4 | steam, steam inflow structure |
| | for desorption |
| 5 | reactor outlet for extraction |
| 6 | vacuum unit/separator |
| 7 | wall |
| 8 | reactor unit |

1. A method for separating gaseous carbon dioxide from a gas mixture, containing said gaseous carbon dioxide as well as further gases different from gaseous carbon dioxide, by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit under temperature and pressure conditions of the supplied gas mixture, in an adsorption step;
(b) isolating said sorbent material with adsorbed carbon dioxide in said unit from said flow-through while maintaining the temperature in the sorbent;
(c) injecting a stream of saturated or superheated steam by flow-through through said unit and thereby inducing an increase of the temperature of the sorbent material to a temperature between 60° and 110° C., starting the desorption of CO₂;
(d) extracting at least the desorbed gaseous carbon dioxide from the unit and separating gaseous carbon dioxide from steam by condensation downstream of the unit;
(e) bringing the sorbent material to the temperature and pressure conditions of the supplied gas mixture;
wherein said sorbent material is a solid inorganic or organic, non-polymeric or polymeric support material functionalized on the surface with amino functionalities capable of reversibly binding carbon dioxide, with a specific BET surface area, in the range of 10-25 m²/g and with a pore volume distribution such that the cumulative pore volume in the range of 50-350 nm is in the range of 0.28-1.5 cm³/g.

2. The method according to claim 1, wherein said sorbent material has a specific BET surface area, measured by nitrogen adsorption, in the range of 10-20 m²/g, or in the range of 12-20 m²/g.

3. The method according to claim 1, wherein said sorbent material has a pore diameter distribution, measured by Mercury intrusion, such that 90%, or 95% of the pore volume is in the range of 50-400 nm,
or wherein said sorbent material has a pore volume distribution, measured by Mercury intrusion, such that the maximum pore volume is at a pore diameter in the range of 80-150 nm, or in the range of 100-150 nm,
or wherein said sorbent material has a total pore volume, measured by mercury intrusion, in the range 0.3-1 cm³/g, or 0.35-0.8 cm³/g, most or in the range of 0.4-0.7 cm³/g.

4. The method according to claim 1, wherein said sorbent material has a nitrogen content in the range 5-50 wt. %, or in the range or 8-15 wt. % or 10-12 wt. %, in each case for dry sorbent material.

5. The method according to claim 1, wherein the gas mixture is ambient atmospheric air.

6. The method according to to claim 1, wherein the solid inorganic or organic, non-polymeric or polymeric support material of the sorbent material is
an organic or inorganic polymeric support,
or is a non-polymeric inorganic support.

7. The method according to claim 1, wherein the solid inorganic or organic, non-polymeric or polymeric support material of the sorbent material functionalized on the surface with amino functionalities is in the form of at least one of monolith, layer or sheet, hollow or solid fibres, including in woven or nonwoven structures, hollow or solid particles, or extrudates,
or wherein the sorbent material of solid inorganic or organic, non-polymeric or polymeric support material functionalized on the surface with amino functionalities is embedded in or attached to a porous/air-permeable or non-porous matrix or carrier structure.

8. The method according to claim 1, wherein said sorbent material has a pore volume distribution such that the cumulative pore volume in the range of 50-350 nm is in the range of 0.3-1.2 cm³/g, or 0.35-0.7 cm³/g.

9. The method according to claim 1, wherein the sorbent material has a water retention in the range of 3-60 weight percent, or in the range of 3-30 weight percent or 5-30 weight percent and/or a bulk density (EN ISO 60 (DIN 53468)) in the range 750-400 kg/m3, or 450-650 kg/m3
or wherein the method is carried out under conditions that the gas mixture or the ambient atmospheric air passing through the sorbent material in step (a), at least during 5% or 10% or 50% of the cycles in one day, one month and/or or over one year, has a relative humidity varying in the range of 20-80% RH.

10. The method according to claim 1, wherein step (d) is carried out in that still contacting the sorbent material with steam by injecting and/or circulating saturated or superheated steam into said unit, thereby flushing and purging both steam and CO₂ from the unit, while regulating the extraction and/or steam supply to essentially maintain the temperature in the sorbent at the end of the preceding step (c) and/or to essentially maintain the pressure in the sorbent at the end of the preceding step (c).

11. The method according to claim 1, wherein it is using a unit containing said sorbent material, the unit and the sorbent material being able to sustain a temperature of at least 60° C. for the desorption of at least said gaseous carbon dioxide and the unit being openable to flow-through of the gas mixture, and for contacting it with the sorbent material for the adsorption step.

12. The method according to claim 1, wherein said unit is evacuable to a vacuum pressure of 400 mbar(abs) or less, and wherein step (b) includes isolating said sorbent with adsorbed carbon dioxide in said unit from said flow-through while maintaining the temperature in the sorbent and then evacuating said unit to a pressure in the range of 20-400 mbar(abs), wherein in step (c) injecting a stream of saturated or superheated steam is also inducing an increase in internal pressure of the reactor unit, and wherein step (e) includes bringing the sorbent material to ambient atmospheric pressure conditions and ambient atmospheric temperature conditions.

13. The method according to claim 1, wherein step (e) is carried out exclusively by contacting said ambient atmospheric air with the sorbent material under ambient atmospheric pressure conditions and ambient atmospheric temperature conditions to evaporate and carry away water in the unit and to bring the sorbent material to ambient atmospheric temperature conditions.

14. A method of using a sorbent material having a solid inorganic or organic, non-polymeric or polymeric support material functionalized on the surface with amino functionalities capable of reversibly binding carbon dioxide, with a specific BET surface area, measured by nitrogen adsorption, in the range of 10-25 m²/g and with a pore volume distribution such that the cumulative pore volume in the range of 50-350 nm is in the range of 0.28-1.5 cm³/g or 0.3-1.5 cm³/g, said sorbent material being used as such or attached to or embedded in a porous and/or non-porous matrix and/or cater structure, separating gaseous carbon dioxide from a gas mixture using the sorbent material.

15. A unit for separating gaseous carbon dioxide from a gas mixture, comprising at least one reactor unit containing sorbent material suitable and adapted for flow-through of said gas mixture,
wherein the reactor unit comprises an inlet for said gas mixture,
wherein the reactor unit is heatable to a temperature of at least 60° C. for the desorption of at least said gaseous carbon dioxide and the reactor unit being openable to flow-through of the gas mixture, and for contacting it with the sorbent material for an adsorption step,
wherein said sorbent material comprises a solid inorganic or organic, non-polymeric or polymeric support material functionalized on the surface with amino functionalities capable of reversibly binding carbon dioxide, with a specific BET surface area, measured by nitrogen adsorption, in the range of 10-25 m²/g and with a pore volume distribution such that the cumulative pore volume in the range of 50-350 nm is in the range of 0.28-1.5 cm³/g or 0.3-1.5 cm³/g,
at least one device, for separating carbon dioxide from water.

16. The method according to claim 1, wherein said gas mixture selected from at least one of ambient atmospheric air, flue gas and biogas

17. The method according to claim 1, wherein said sorbent material has a pore diameter distribution, measured by Mercury intrusion, such that 90%, or 95% of the pore volume is in the range of 80-350 nm,
or wherein said sorbent material has a pore volume distribution, measured by Mercury intrusion, such that the maximum pore volume is at a pore diameter in the range of 80-150 nm, or in the range of 100-150 nm, wherein 90%, or 95% of the total pore volume of the distribution is in a window of −50 nm and +150 nm, or of −40 and +100 nm around the diameter of said maximum of the pore volume distribution.

18. The method according to claim 1, wherein the solid inorganic or organic, non-polymeric or polymeric support material of the sorbent material is
an organic polymeric support, in the form of a polystyrene based material, to form the sorbent material surface functionalised with primary amine,
or is a non-polymeric inorganic support, selected from the group consisting of silica (SiO₂), alumina (Al₂O₃), titania (TiO₂), magnesia (MgO), clays, as well as mixed forms thereof, such as silica-alumina (SiO₂—Al₂O₃), or mixtures thereof.

19. The method according to claim 1, wherein the solid inorganic or organic, non-polymeric or polymeric support material of the sorbent material is a styrene divinylbenzene copolymer, to form the sorbent material surface functionalised with primary amine, in the form methyl amine, or benzylamine moieties, wherein the solid polymeric support material is obtained in a suspension and/or an emulsion polymerisation process.

20. The method according to claim 1, wherein the solid inorganic or organic, non-polymeric or polymeric support material of the sorbent material functionalized on the surface with amino functionalities is in the form of essentially spherical beads with a particle size (D50) in the range of 0.002-4 mm or 0.01-1.5 mm, or in the range of 0.30-1.25 mm,
or wherein the sorbent material of solid inorganic or organic, non-polymeric or polymeric support material functionalized on the surface with amino functionalities is, in the form of solid particles and/or fibres, embedded in or attached to a porous/air-permeable or non-porous matrix or carrier structure.

21. The method according to claim 1, wherein the sorbent material takes the form of a layer of sorbent material, including of particulate and/or fibre form, which is attached to at least one further layer of porous/air permeable carrier material, including porous/air permeable polymeric carrier material.

22. The method according to claim 21, wherein, the layer of sorbent material is embedded between two layers of porous/air permeable carrier material to form a laminate, which itself can be further structured to form panels or modules.

23. The method according to claim 11, wherein the unit comprises an array of individual adsorber elements, each adsorber element comprising at least one support layer and at least one sorbent layer comprising or consisting of at least one sorbent material, where said sorbent material offers selective adsorption of CO₂ in the presence of moisture or water vapor, wherein the adsorber elements in the array are arranged essentially parallel to each other and spaced apart from each other forming parallel fluid passages for flow-through of gas mixture.

24. The method according to claim 12, wherein after step (d) and before step (e) the following step is carried out:
(d1) ceasing the injection and, if used, circulation of steam, and evacuation of the unit to pressure values between 20-500 mbar(abs), or in the range of 50-250 mbar(abs) in the unit, thereby causing evaporation of water from the sorbent and both drying and cooling the sorbent.

25. The method according to claim 14, wherein it is for separating gaseous carbon dioxide from at least one of ambient atmospheric air, flue gas and biogas.

26. The method according to claim 14, wherein the method is for direct air capture.

27. The method according to claim 14, comprising using a temperature, vacuum, or temperature/vacuum swing process, using a process in which injecting a stream of saturated or superheated steam by flow-through is used for inducing an increase of the temperature of the sorbent material to a temperature between 6° and 110° C., starting the desorption of CO₂.

28. The unit according to claim 15, wherein the reactor unit comprises an inlet for ambient air, and an outlet for ambient air during adsorption,
wherein the reactor unit is heatable to a temperature of at least 60° C. for the desorption of at least said gaseous carbon dioxide and the reactor unit being openable to flow-through of the ambient atmospheric air, and for contacting it with the sorbent material for an adsorption step, wherein the reactor unit is further evacuable to a vacuum pressure of 400 mbar(abs) or less.

29. The unit according to claim 15, wherein the sorbent material takes the form of at least part of an adsorber structure comprising an array of individual adsorber elements, each adsorber element comprising at least one monolith or support layer or sheet and at least one sorbent material layer or sorbent material monolith comprising or consisting of at least one sorbent material, wherein the adsorber elements in the array are arranged essentially parallel to each other and spaced apart from each other forming parallel fluid passages for flow-through of said gas mixture.

30. The unit according to claim 15, wherein said at least one device for separating carbon dioxide from water is a condenser,
or wherein at the gas outlet side of said device for separating carbon dioxide from water, there is at least one of, or both of a carbon dioxide concentration sensor and a gas flow sensor for controlling the desorption process.
